(19) United States
(12) Patent Application Publication
(10) Pub. No.: US 2014/0195999 A1
(43) Pub. Date: Jul. 10, 2014

(54) METHOD OF DESIGNING SEMICONDUCTOR INTEGRATED CIRCUIT

(71) Applicant: FUJITSU LIMITED, Kawasaki-shi (JP)

(72) Inventor: Shinichi NAKAMOTO, Tachikawa (JP)

(73) Assignee: FUJITSU LIMITED, Kawasaki-shi (JP)

(21) Appl. No.: 14/206,023

(22) Filed: Mar. 12, 2014

Related U.S. Application Data
(63) Continuation of application No. PCT/JP2011/070895, filed on Sep. 13, 2011.

(51) Int. Cl. G06F 17/50

(52) U.S. Cl. CPC G06F 17/505
USPC 716/133

(57) ABSTRACT

A method of designing a semiconductor integrated circuit, includes inserting, between a power supply voltage and a ground voltage, at least two types of capacitor cells which have a different ratio, the ratio being between an inverse number of a capacitance value of a capacitative element and a resistance value of an equivalent series resistance, such that an impedance between the power supply voltage and the ground voltage in a resonance frequency according to capacitances of the at least two types of capacitor cells and an external inductance, and an impedance between the power supply voltage and the ground voltage in a target frequency, are near respective desired values or less than or equal to the respective desired values.

### CROSS-REFERENCE TO RELATED APPLICATION

This application is a U.S. continuation application filed under 35 USC 111(a) claiming benefit under 35 USC 120 and 365(c) of PCT Application PCT/JP2011/070895 filed on Sep. 13, 2011, and designated the U.S., the entire contents of which are incorporated herein by reference.

### FIELD

The embodiments discussed herein are related to a method of designing a semiconductor integrated circuit.

### BACKGROUND

In a power supply system, when the power supply voltage changes due to noise, there is a possibility of malfunction of the semiconductor integrated circuit. Accordingly, by inserting a capacitative element (decoupling capacitor) between the power supply wiring of the HIGH side potential and the power supply wiring of the LOW side (ground side) potential, the impedance of the power supply system is decreased, and the power supply noise is decreased. Such a capacitative element is provided in at least one of a printed-circuit board, a package, and inside an LSI (Large Scale Integration circuit) chip. When the capacitative element is disposed inside an LSI chip, a capacitor cell is prepared similarly to a logical cell, and the needed number of capacitor cells are arranged inside the LSI.

When an attempt is made to secure a sufficient capacitance value by arranging multiple capacitor cells in parallel, the ESR (equivalent series resistance) value of the capacitor cell becomes low. In this case, a resonance occurs due to these capacitance components and induction components of the package, and the impedance becomes high in a particular frequency. In the operation frequency of the LSI, even when the impedance is a desired low value, if there are resonance points where the impedance is high in other frequency positions, when variations occur in the current corresponding to nearby frequencies, a large power supply voltage noise occurs. In order to prevent such a large power supply voltage noise from occurring, it is desired to prevent a resonance.

In order to prevent a resonance, it is effective to insert a resistance. However, when an attempt is made to prevent a resonance by increasing the resonance value, it becomes difficult to achieve a desired low impedance value in the operation frequency due to the increase in the resistance value. Conversely, when the resistance value is decreased in attempt to achieve a desired low impedance value in the operation frequency, a resonance tends to occur. As described above, it is desired to realize an appropriate impedance value that satisfies requests that conflict with each other, i.e., a request to increase the resistance value to prevent a resonance, and a request to achieve a desired low impedance value in the operation frequency.

The method of inserting a resistance may be performed by inserting a resistance in series with the capacitative element between the power supply and ground outside the LSI, inserting a resistance in the middle of a power supply path, inserting a resistance as an ESR of a capacitor cell in the LSI, etc. In the case of inserting a resistance in series with the capacitative element between the power supply and ground outside the LSI, in order to realize a resistance value as an ESR of the capacitor cell, it is needed to newly develop a capacitor having an appropriate ESR value matching the optimum resistance value that differs for each LSI. As an alternate solution, an appropriate ESR value may be realized by arranging capacitors having large ESR values in parallel; however, in this case, an excessive number of multiple capacitors are installed, and a large area is needed as a capacitor arrangement area in the package, etc. A desired ESR value may be realized by a lead-out wiring pattern of the capacitor, etc.; however, if the wiring pattern is extended, the inductance increases, which leads to an increase in power supply noise. In order to suppress this, the capacity value of the capacitor needs to be increased, which increases the cost and the circuit area.

In the case of inserting a resistance in the middle of a power supply path, a special structure is used, such as using a high-resistance via in the package and reducing the thickness of the conductor, for the purpose of increasing the resistance components in the supply path of the package, which leads to an increase in cost. Furthermore, the inductance increases in accordance with the increase in the resistance value, which leads to an increase in the power supply noise. Furthermore, an increase in the resistance in the power supply path causes problems such as a voltage drop, power loss, and heat generation in the supply path.

When a resistance is inserted as an ESR of the capacitor cell inside the LSI, there are no problems such as those that arise in the case of inserting a resistance outside the LSI or inserting a resistance in the middle of a power supply path as described above. However, generally, as the capacitor cells inside the LSI, only capacitor cells having about the same level of ESR per capacitor cell are performed. Therefore, in order to arrange a number of capacitor cells needed for achieving the desired capacitance value, the ESR value is determined according to the number of arranged capacitor cells, and therefore it is not possible to control the ESR value to be a desired value.

Furthermore, as described above, there are requests that conflict with each other, i.e., a request to increase the resistance value to prevent a resonance, and a request to achieve a desired low impedance value in the operation frequency. Therefore, even when a resistance is inserted as an ESR of the capacitor cell inside the LSI, it is desired to realize an appropriate impedance value by which these conflicting requests are satisfied. That is to say, it is desired to achieve a desired impedance value for each of the frequency bands across all frequency domains.

Patent Document 1 discloses a configuration of dividing the power supply path and inserting a resistance. In this configuration, the inductance increases corresponding to the division of the power supply path. Furthermore, the voltage decreases due to the resistance. Patent Document 2 discloses a method of designing a LSI by using a capacitative element without a resistance and a capacitative element with a resistance. The purpose of this method is to prevent a resonance of the impedance of the power supply, or to shift the resonance frequency, and there are cases where it is not possible to achieve a desired impedance value across all frequency domains.
Patent Document 1: Japanese Laid-Open Patent Publication No. 2009-290841
Patent Document 2: Japanese Laid-Open Patent Publication No. 2008-251571
Patent Document 3: Japanese Laid-Open Patent Publication No. 2011-014629
Patent Document 4: Japanese Laid-Open Patent Publication No. S54-021566

### SUMMARY

According to an aspect of the embodiments, a method of designing a semiconductor integrated circuit, includes inserting, between a power supply voltage and a ground voltage, at least two types of capacitor cells which have a different ratio, the ratio being between an inverse number of a capacitance value of a capacitative element and a resistance value of an equivalent series resistance, such that an impedance between the power supply voltage and the ground voltage in a resonance frequency according to capacitances of the at least two types of capacitor cells and an external inductance, and an impedance between the power supply voltage and the ground voltage in a target frequency, are near respective desired values or less than or equal to the respective desired values.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates an AC equivalent circuit of a power supply wiring of a semiconductor device according to an embodiment;

FIG. 2 schematically illustrates the desired impedance in each frequency band of the semiconductor device of FIG. 1;

FIG. 3 illustrates two or more types of capacitor cells;

FIG. 4 illustrates the power supply impedance of a semiconductor device in a case where one type of capacitor cell is used;

FIG. 5 illustrates a power supply impedance of a semiconductor device in a case where two types of capacitor cells are used;

FIG. 6 illustrates a flow of a method of designing a semiconductor integrated circuit;

FIG. 7 schematically illustrates a process of designing a first capacitor cell and a second capacitor cell;

FIG. 8 schematically illustrates a process of calculating n1 and n2;

FIG. 9 is a flowchart indicating the flow of a process of arranging capacitor cells;

FIG. 10 illustrates impedance properties realized by combining two types of capacitor cells;

FIG. 11 illustrates a modification of the AC equivalent circuit of the power supply wiring of the semiconductor device illustrated in FIG. 1;

FIG. 12 schematically illustrates the desired impedances in the respective frequency bands of the semiconductor device illustrated in FIG. 11;

FIGS. 13A through 13D illustrate a configuration for adjusting the equivalent series resistance in a capacitor cell;

FIGS. 14A through 14D illustrate a configuration for adjusting the equivalent series resistance in a capacitor cell;

FIG. 15 illustrates a configuration by which it is possible to adjust the equivalent series resistance value with respect to the capacitance at the time of operation; and

FIG. 16 illustrates a configuration of a device for executing a method of designing a semiconductor integrated circuit for arranging capacitor cells.

### DESCRIPTION OF EMBODIMENTS

Preferred embodiments of the present invention will be explained with reference to accompanying drawings.

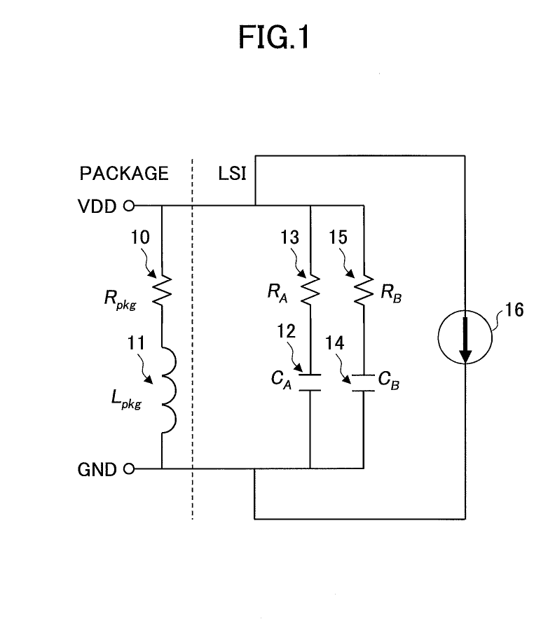

FIG. 1 illustrates an AC equivalent circuit of a power supply wiring of a semiconductor device according to an embodiment. The AC equivalent circuit of the power supply wiring of the semiconductor device illustrated in FIG. 1 includes a parasitic resistance 10 and a parasitic inductance 11 on the package side; and a first capacitative element 12, an equivalent serial resistance 13, a second capacitative element 14, an equivalent serial resistance 15, and an AC current supply 16, on the LSI (Large Scale Integration circuit) side. On the package side, between a power supply voltage VDD and a ground voltage GND, the parasitic resistance 10 and the parasitic inductance 11 are present. More specifically, there is a parasitic capacitative element provided in series with the parasitic resistance 10 and the parasitic inductance 11; however, the capacitance value of this parasitic capacitative element is high, and the impedance is negligibly low in the frequency band of AC components relevant to operations of the LSI. In FIG. 1, this parasitic capacitative element having a negligibly low impedance is not illustrated. The resistance value of the parasitic resistance 10 is R_{pkg}, and the inductance value of the parasitic inductance 11 is L_{pkg}.

In parallel with the parasitic resistance 10 and the parasitic inductance 11 on the package side, on the LSI side, the first capacitative element 12 and the equivalent serial resistance 13 are inserted between the power supply voltage VDD and the ground voltage GND. Similarly, in parallel with the parasitic resistance 10 and the parasitic inductance 11 on the package side, on the LSI side, the second capacitative element 14 and the equivalent serial resistance 15 are inserted between the power supply voltage VDD and the ground voltage GND. The first capacitative element 12, the equivalent serial resistance 13, the second capacitative element 14, and the equivalent serial resistance 15 are circuit elements that are explicitly inserted between the power supply voltage VDD and the ground voltage GND as capacitor cells in the LSI. The capacitance value of the first capacitative element 12 is C_{A}, and the resistance value of the equivalent serial resistance 13 is R_{A}. The capacitance value of the second capacitative element 14 is C_{B}, and the resistance value of the equivalent serial resistance 15 is R_{B}.

The AC current supply 16 expresses, as a current supply, the internal circuit in the LSI consuming a current in accordance with operations of the LSI. When the internal circuit in the LSI operates by a certain operation frequency, the AC current supply 16 becomes a current supply whose current amount varies according to the operation frequency.

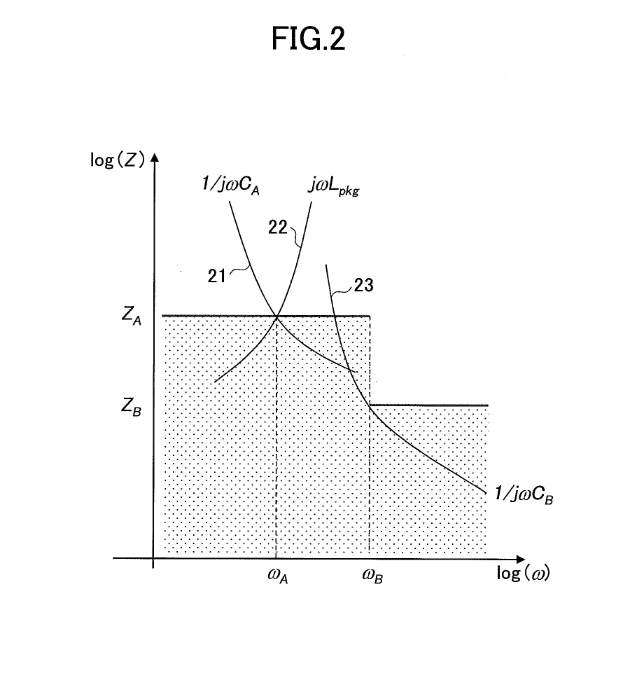

FIG. 2 schematically illustrates the desired impedance in each frequency band of the semiconductor device of FIG. 1. The horizontal axis indicates the frequency, and the vertical axis indicates the impedance. As illustrated in FIG. 2, the semiconductor device of FIG. 1 is designed to have an impedance that is near a first desired impedance Z_{A} or less than or equal to the first desired impedance Z_{A}, between the power supply voltage VDD and the ground voltage GND, in a domain less than or equal to a target frequency ω_{B}. Particularly, the semiconductor device is designed to have an impedance that is near a first desired impedance Z_{A} or less than or equal to the first desired impedance Z_{A}, between the power supply voltage VDD and the ground voltage GND, in a domain less than or equal to the target frequency ω_{B}, at a resonance frequency ω_{A} of the power supply wiring of the semiconductor. Furthermore, the semiconductor device of FIG. 1 is designed to have an impedance that is near a second desired impedance Z_{E}, or less than or equal to the second desired impedance Z_{B}, between the power supply voltage VDD and the ground voltage GND, in a domain greater than or equal to a target frequency ω_{B}. The operation frequency of the LSI of FIG. 1 may be in a domain that is greater than or equal to the target frequency ω_{B}.

Near the operation frequency of a high frequency, there are significant current variations of the high frequency caused by clocks, and therefore the target value Z_{E}, of the power supply impedance (second desired impedance Z_{B}) is set to be a low value. Furthermore, in a frequency lower than the operation frequency, current variations occur according to the switching of driving/non-driving of the circuit; however, these current variations are usually less than the current variations near the operation frequency. Therefore, the first desired impedance Z_{A} may be a larger value than the second desired impedance Z_{B}.

For the semiconductor device of FIG. 1, at least two types of capacitor cells (the capacitor cells 12, 13, and the capacitor cells 14, 15) are prepared, which have a different ratio, the ratio being between the inverse number of the capacitance value C_{A} (or C_{B}) of the capacitative element and the resistance value of the equivalent series resistance R_{A} (or R_{B}). Then, the at least two type types of capacitor cells are inserted between the power supply voltage VDD and the ground voltage GND, such that the impedance between the power supply voltage VDD and the ground voltage GND is set to be an appropriate value. At this time, the capacitor cells are designed such that the impedance at the resonance frequency ω_{A} according to the capacitances of the capacitor cells and an external inductance L_{pkg}, and the impedance at a target frequency ω_{B} become near the respective desired values Z_{A} and Z_{E}, or less than or equal to the respective desired values Z_{A} and Z_{B}.

Note that the first capacitative element 12 and the equivalent serial resistance 13 may be a single capacitor cell, or may be combined capacitative elements and combined equivalent series resistances formed by connecting a plurality of capacitor cells in parallel. Similarly, the second capacitative element 14 and the equivalent serial resistance 15 may be a single capacitor cell, or may be combined capacitative elements and combined equivalent series resistances formed by connecting a plurality of capacitor cells in parallel. That is to say, the first capacitative element 12 and the equivalent serial resistance 13 of the first capacitative element 12 may be realized by connecting in parallel one or a plurality of first capacitor cells having a predetermined capacitance and equivalent series resistance. Furthermore, the second capacitative element 14 and the equivalent serial resistance 15 of the second capacitative element 14 may be realized by connecting in parallel one or a plurality of second capacitor cells having a predetermined capacitance and equivalent series resistance.

As described above, when a plurality of types of capacitor cells have a different ratio, the ratio being between the inverse number of the capacitance value of the capacitative element and the resistance value of the equivalent series resistance, it means that the plurality of types of capacitor cells have a different ratio, the ratio being between the capacitance reactance value and the resistance value in each frequency. It is assumed that two capacitor cells have a different ratio, the ratio being between the inverse number of the capacitance value of the capacitative element and the resistance value of the equivalent series resistance. At this time, the impedance of a serial connection of a capacitative element and an equivalent series resistance in the first capacitor cell is not a real number multiple of the impedance of a serial connection of a capacitative element and an equivalent series resistance in the second capacitor cell. In other words, the phase angle of the impedance of the first capacitor cell and the phase angle of the impedance of the second capacitor cell are different from each other. In this case, it is not possible to realize an impedance formed by combining first capacitor cells in parallel connection, by connecting second capacitor cells in parallel. Therefore, by generating a combined impedance by connecting in parallel the first capacitor cell and the second capacitor cell which have the above relationship, it is possible to generate an impedance having a property that is not realized by combining only one type of capacitor cells.

Here, the capacitance value C_{A} of the first capacitative element 12 is determined according to a resonance frequency ω_{A}, the inductance L_{pkg} of the parasitic inductance 11, and the first desired impedance Z_{A}. For example, the capacitance value C_{A} may be determined such that the reactance (1/ω_{A}C_{A}) at the resonance frequency ω_{A} of the first capacitative element 12 is equal to both the reactance (ω_{A}L_{pkg}) of the parasitic inductance 11 in the resonance frequency ω_{A} and the first desired impedance Z_{A}. In FIG. 2, a curve 21 of the impedance (1/jωC_{A}) according to the capacitance C_{A} of the first capacitative element 12, and a curve 22 of the impedance (jωL_{pkg}) according to the inductance value L_{pkg} of the parasitic inductance 11, intersect with the impedance Z_{A} at one point. The frequency at this intersection is the resonance frequency ω_{A}. This means that at the resonance frequency ω_{A}, the absolute values of these impedances are all equal. More specifically, the intersection of the curve 21 of the impedance (1/jωC_{A}) and the curve 22 of the impedance (jωL_{pkg}) is the resonance frequency ω_{A}. Then, by sufficiently increasing the resistance value R_{A} of the equivalent serial resistance 13, the impedance of the resonance circuit at the resonance frequency ω_{A} sufficiently approaches near the impedance value (i.e., Z_{A}) of the intersection. That is to say, it is possible to set the impedance of the resonance circuit at the resonance frequency ω_{A} to be near the first desired impedance value Z_{A}. Note that at this time, the capacitance value C_{B} of the second capacitative element 14 is sufficiently lower than the capacitance value C_{A} of the first capacitative element 12, and therefore the impact on the resonance of the capacitance value C_{B} is negligible. That is to say, the impedance of the second capacitative element 14 is sufficiently higher than the impedance of the first capacitative element 12, and the impact of the second capacitative element 14 in the parallel connection circuit illustrated in FIG. 1 is negligible near the resonance frequency ω_{A}.

Furthermore, as to the equivalent serial resistance 13, the higher the resistance value R_{A}, the more it is possible to decrease the impedance of the resonance circuit at the resonance frequency ω_{A}. When the resistance value R_{A} is sufficiently high, the impedance of the resonance circuit at the resonance frequency ω_{A} may sufficiently approach near Z_{A}. However, when the resonance value R_{A} is too high, the impact of the first capacitative element 12 is reduced, which functions as a decoupling capacitative element for reducing power supply voltage noise, and therefore the impact of L_{pkg} on the package side increases relatively. Thus, even though the impedance of the resonance circuit in the resonance frequency ω_{A} is decreased, the impedance of the resonance circuit in a frequency domain higher than the resonance frequency ω_{A} becomes high, and the first desired impedance value Z_{A} is not achieved. Accordingly, the resistance value R_{A} of the equivalent serial resistance 13 of the first capacitative element 12 is preferably determined to be an appropriate value according to the first desired impedance Z_{A}. For example, the resistance value R_{A} of the equivalent serial resistance 13 of the first capacitative element 12 may be determined to be substantially equal to the first desired impedance Z_{A}.

The capacitance value C_{B} of the second capacitative element 14 may be determined according to the target frequency ω_{B} and the second desired impedance Z_{B}. For example, the capacitance value C_{B} of the second capacitative element 14 may be determined such that the reactance (1/ω_{B}C_{B}) at the target frequency ω_{B} of the second capacitative element 14 is less than or equal to the second desired impedance Z_{B}. In FIG. 2, the curve 23 of the impedance (1/jωC_{B}) according to the capacitance value C_{B} of the second capacitative element 14 and the impedance Z_{B} intersect at the target frequency ω_{B}. Therefore, the capacitance value C_{B} of the second capacitative element 14 corresponding to such a curve 23 becomes the upper limit of the capacitance value C_{B}.

Furthermore, the resistance value R_{B} of the equivalent serial resistance 15 of the second capacitative element 14 may be determined according to the second desired impedance Z_{B}. For example, the resistance value R_{B} of the equivalent serial resistance 15 of the second capacitative element 14 may be determined to be less than or equal to the second desired impedance Z_{B}.

Accordingly, the absolute value of the impedance of the second capacitative element 14 and the equivalent serial resistance 15 becomes less than or equal to √2·Z_{B}, and the impedance at the target frequency ω_{B} is set to be near the desired value Z_{E}, or less than or equal to the desired value Z_{B}. Note that at this time, the resistance value R_{A}(≈Z_{A}) of the equivalent serial resistance 13 is sufficiently high, and therefore the impact of the first capacitative element 12 and the equivalent serial resistance 13 in the parallel connection circuit illustrated in FIG. 1 is negligible near the target frequency ω_{B}.

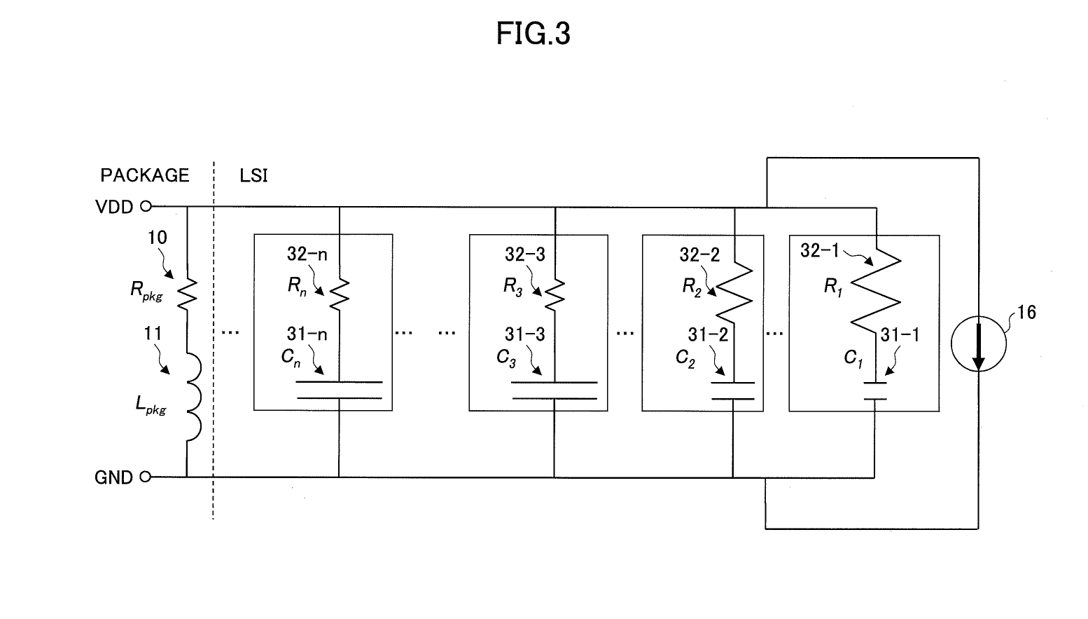

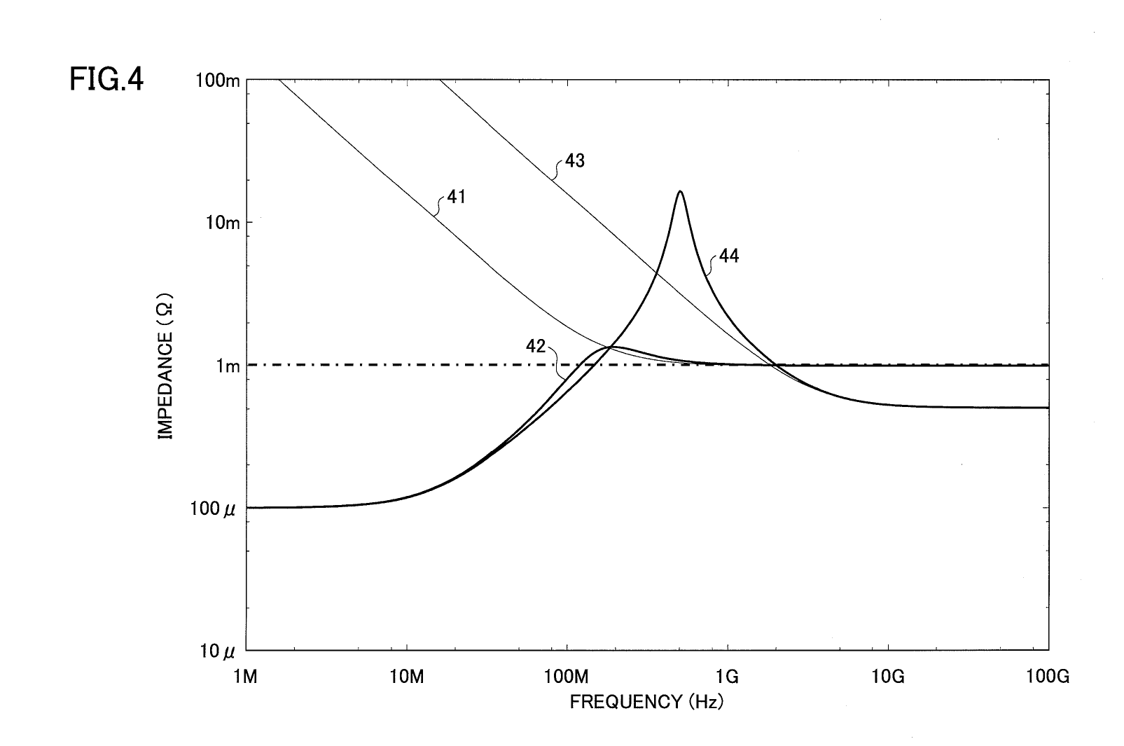

FIG. 3 illustrates two or more types of capacitor cells. In FIG. 3, the same elements as those of FIG. 1 are denoted by the same reference numerals, and descriptions thereof are omitted. In the example of FIG. 1, two types of capacitor cells are used, which have a different ratio, the ratio being between the inverse number of the capacitance value of the capacitative element and the resistance value of the equivalent series resistance. Meanwhile, in the example of FIG. 4, n types of capacitor cells are used, which have a different ratio, the ratio being between the inverse number of the capacitance value of the capacitative element and the resistance value of the equivalent series resistance. The value of n may be an arbitrary value of three or more. The n types of capacitor cells include capacitative elements 31-1 through 31-n and equivalent series resistances 32-1 through 32-n. The capacitance values of the capacitative elements 31-1 through 31-n are C₁ through Cₙ, respectively, and the resistance values of the equivalent series resistances 32-1 through 32-n are R₁ through Rₙ, respectively. The impedance between the power supply voltage VDD and the ground voltage GND may be set to an appropriate value by inserting these n types of capacitor cells between the power supply voltage VDD and the ground voltage GND. At this time, the capacitor cells may be designed such that the impedance at the resonance frequency ω_{A} according to the capacitances of the capacitor cells and an external inductance L_{pkg}, and the impedance at a plurality of target frequencies, are near the respective desired values or less than or equal to the respective desired values.

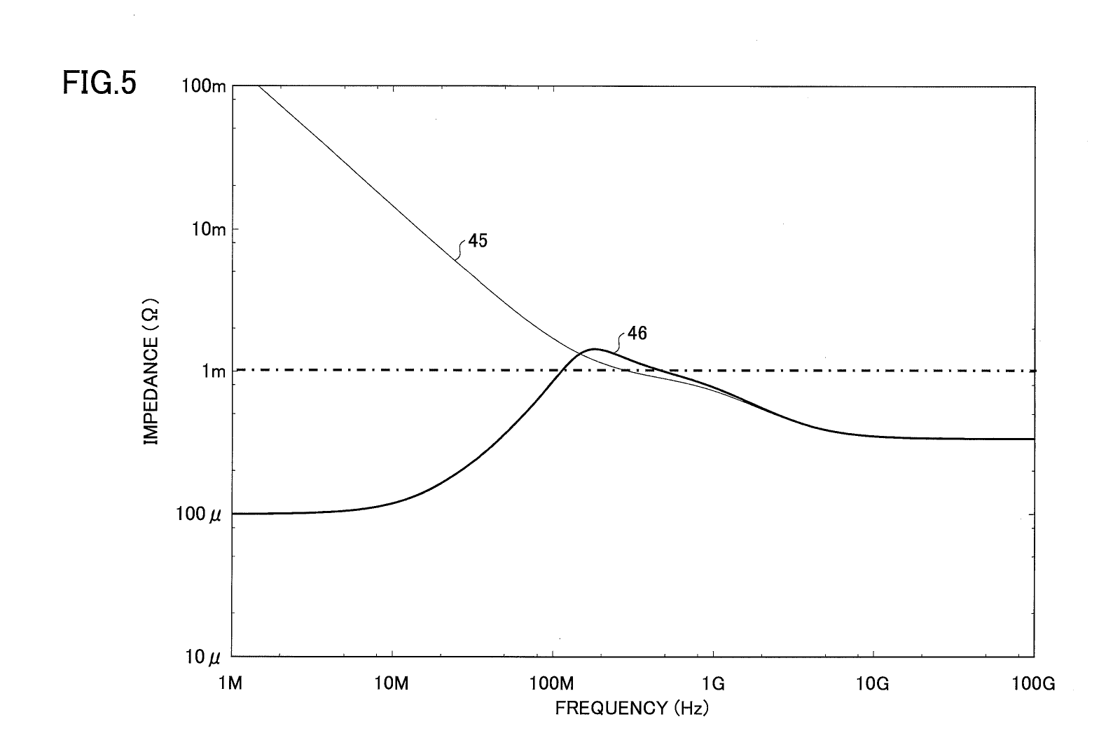

FIGS. 4 and 5 are for describing the effect of achieving a desired impedance by two types of different capacitor cells. In FIGS. 4 and 5, the horizontal axis expresses the frequency and the vertical axis expresses the impedance.

FIG. 4 illustrates the power supply impedance of a semiconductor device in a case where one type of capacitor cell is used. An impedance curve 41 indicates an impedance (R_{A}+1/jωC_{A}) according to a capacitance value C_{A} of the first capacitative element 12 and a resistance value R_{A} of the equivalent serial resistance 13 of the first capacitative element 12 illustrated in FIG. 1. When the impedance of the impedance curve 41 and the parasitic inductance 11 (see FIG. 1) are combined by parallel connection, the impedance indicated by an impedance curve 42 is obtained. In this case, with the impedance curve 42, the resonance is sufficiently suppressed by the equivalent series resistance; however, because the resistance value R_{A} of the equivalent series resistance is high, a desired low impedance is not achieved in the high frequency domain.

The impedance curve 43 indicates an impedance (R_{B}+1/jωC_{B}) according to a capacitance value C_{B} of the second capacitative element 14, and a resistance value R_{B} of the equivalent serial resistance 15 of the second capacitative element 14 illustrated in FIG. 1. When the impedance of the impedance curve 43 and the parasitic inductance 11 (see FIG. 1) are combined by parallel connection, the impedance indicated by an impedance curve 44 is obtained. In this case, the impedance curve 44 does not sufficiently suppress the resonance because the equivalent series resistance R_{B} is low; however, a desired low impedance is achieved in the high frequency domain.

As described above, in a case where only the first capacitative element 12 and the equivalent serial resistance 13 are used, a desired impedance is realized in the resonance frequency; however, a low impedance in the high frequency is not realized. On the other hand, in a case where only the second capacitative element 14 and the equivalent serial resistance 15 are used, a desired impedance is not realized in the resonance frequency; however, a low impedance in the high frequency is realized. As described above, by using only one type of capacitor cell, it is not possible to achieve a desired impedance value in each frequency band across all frequency domains.

FIG. 5 illustrates a power supply impedance of a semiconductor device in a case where two types of capacitor cells are used. An impedance curve 45 indicates a combined impedance according to a capacitance value C_{A} of the first capacitative element 12, a resistance value R_{A} of the equivalent serial resistance 13, a capacitance value C_{B} of the second capacitative element 14, and a resistance value R_{B} of the equivalent serial resistance 15, which are connected as illustrated in FIG. 1. Unlike the curves 41 and 43 illustrated in FIG. 4, the impedance curve 45 illustrated in FIG. 5 has an inflection point by including an item of 1/ω² other than the item of 1/ω, and thus has a shape that bends in two stages. When the impedance of the impedance curve 45 and the parasitic inductance 11 (see FIG. 1) are combined by parallel connection, the impedance indicated by an impedance curve 46 is obtained. In this case, the impedance curve 46 sufficiently suppresses the resonance by the equivalent series resistance, and further achieves a desired low impedance in the high frequency domain. That is to say, by the first capacitative element 12, the equivalent serial resistance 13, the second capacitative element 14, and the equivalent serial resistance 15 illustrated in FIG. 1, a desired impedance in the resonance frequency is realized, and furthermore, a low impedance is realized in the high frequency.

In step S1, the above-described L_{pkg}, R_{pkg}, Z_{A}, Z_{B}, and ω_{B} are input to the design system. A design system includes a computer for executing, by a CPU, a program for realizing the method of designing a semiconductor integrated circuit, a display for displaying data, and an input device for inputting data and instructions.

The first desired impedance Z_{A}, the second desired impedance Z_{B}, and the target frequency ω_{B} are determined from the current variation amount and the allowable noise amount of the LSI that is the design target. These values are the target values when designing an LSI, for suppressing noise. Furthermore, the external inductance L_{pkg} and resistance value R_{pkg} of a package, etc., in which the LSI is installed, are calculated in advance by specification data or actual measurement of the package. When the resistance value R_{pkg} of the package in which the LSI is installed is less than the target impedance Z_{A}, the impedance deteriorates due to resonance, and therefore impedance adjustment is performed as described below by inserting a plurality of types of capacitor cells.

In step S2, the above described C_{A}, R_{A}, C_{B}, and R_{E}, are calculated as described below. The impedance of L_{pkg} rises in proportion to the frequency. Thus, C_{A} needs to be inserted so that the overall impedance does not exceed Z_{A} due to the impact of the impedance of L_{pkg}. Assuming that the resonance point of L_{pkg} and C_{A} is ω_{A}, the impedance at ω_{A} becomes Z_{A}, and therefore the package side illustrated in FIG. 1 is expressed as follows.

Z_{A}=|jω_{A}L_{pkg}| Formula 1

Therefore, ω_{A} may be expressed as follows by the known Z_{A} and L_{pkg}.

$${ω}_{A} = \frac{{Z}_{A}}{{L}_{pkg}} \qquad Formula 2$$

Furthermore, the impedance of the C_{A} on the LSI side illustrated in FIG. 1 is similarly expressed as follows.

$${Z}_{A} = \vert \frac{1}{{jω}_{A} {C}_{A}} \vert \qquad Formula 3$$

That is to say, C_{A} is determined from ω_{A} and Z_{A} that are known from external conditions. Therefore, the capacitance C_{A} that is needed may be determined as follows, based on the condition L_{pkg} of the package in which the LSI is installed and Z_{A} that is determined from the power, etc., of the LSI.

$${C}_{A} = \frac{{L}_{pkg}}{{Z}_{A}^{2}} \qquad Formula 4$$

Next, the equivalent series resistance component R_{A} needed for the combined capacitor cell C_{A} for suppressing the resonance according to L_{pkg} and C_{A}, is calculated. By setting the value of R_{A} to be substantially equal to Z_{A}, the power supply impedance does not significantly exceed Z_{A} at the resonance point ω_{A}.

R_{A}≅Z_{A} Formula 5

As described above, it is possible to determine the combination properties C_{A} and R_{A} of the capacitor cell inside the LSI, which are needed for achieving the target impedance Z_{A}. When R_{A} is too low, a resonance occurs, and the impedance at the resonance frequency significantly exceeds the target value Z_{A}. Conversely, when R_{A} is too high, the capacitor cell does not sufficiently function as a decoupling capacitor, and the impact of L_{pkg} increases relatively, and therefore a frequency band is generated in which the impedance exceeds the target value Z_{A}. Thus, R_{A} needs to be an appropriate value. Furthermore, as the target impedance Z_{A} becomes low, the needed amount of C_{A} increases. Furthermore, when a package has bad package properties and a high inductance L_{pkg}, the needed amount of C_{A} increases. It is possible to set a capacitance value that is higher than the C_{A} amount determined as described above; however, in order to do so, many capacitor cells are usually needed. Depending on the design value of the capacitor cell, many capacitor cells may be connected in parallel, which may decrease the R_{A}. Therefore, C_{A} is determined to be the requisite minimum value.

Next, C_{B} and R_{B} of the capacitor cell inside the LSI are calculated, which are needed so as not to exceed the Z_{B} in the band higher than ω_{B}. The capacitance C_{B} inside the LSI for achieving Z_{B} at ω_{B}, is calculated as follows.

$${Z}_{B} > \frac{1}{{ω}_{B} {C}_{B}} \qquad Formula 6$$

Accordingly, C_{B} is determined as follows.

$${C}_{B} > \frac{1}{{ω}_{B} {Z}_{B}} \qquad Formula 7$$

Furthermore, in order to decrease the impedance, the equivalent series resistance value R_{B} of the combined capacitance inside the LSI needs to be lower than Z_{B}.

R_{B}<Z_{B} Formula 8

As described above, the values of combined capacitances C_{A}, C_{B} and the values of combined equivalent series resistances R_{A}, R_{B} needed inside the LSI are determined. Furthermore, the capacitor cell for realizing the combined capacitance and the combined equivalent series resistance is designed as follows.

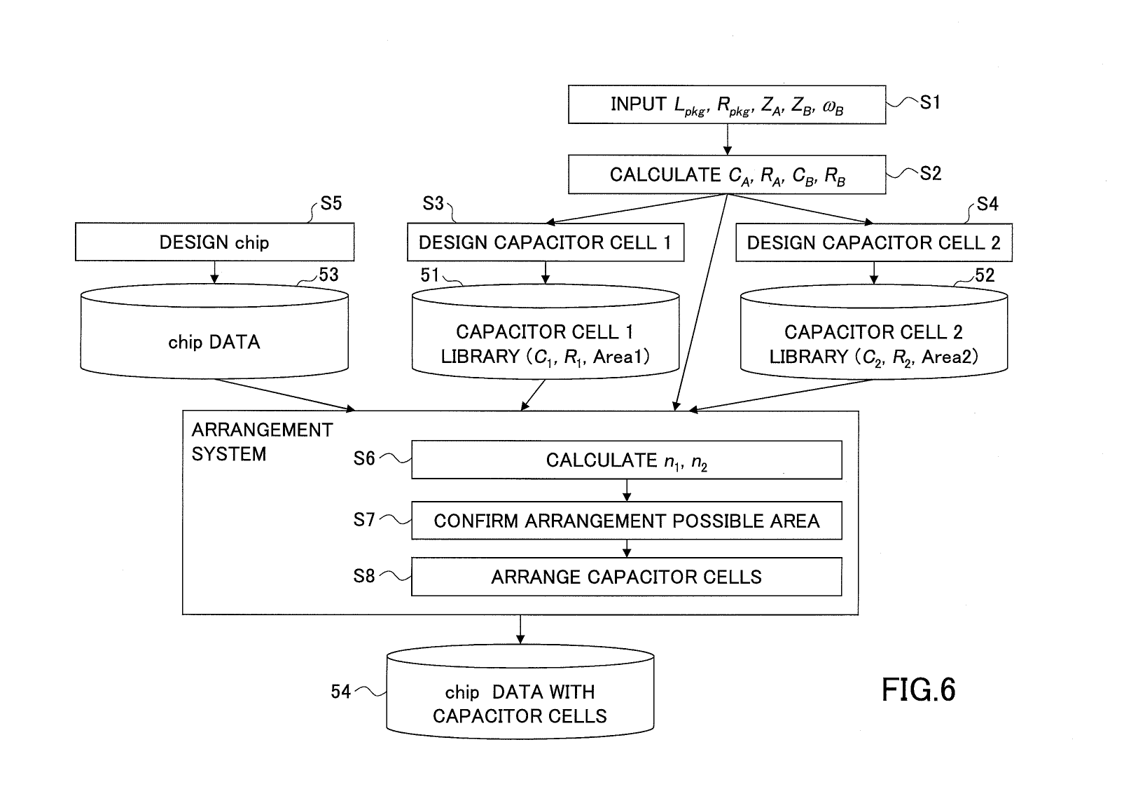

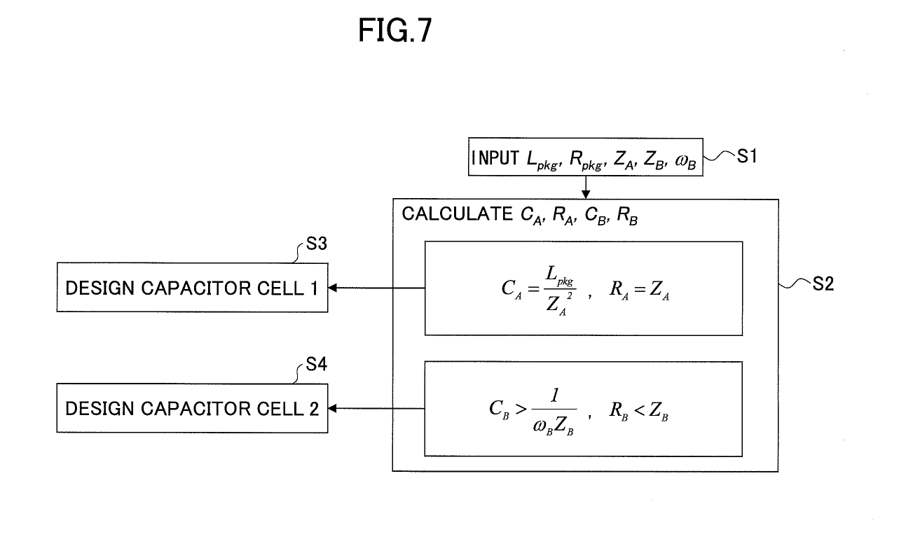

Referring back to FIG. 6, in step S3, a capacitor cell 1 is designed, and in step S4, a capacitor cell 2 is designed. At this time, as illustrated in FIG. 7, the capacitor cell 1 and the capacitor cell 2 are designed based on C_{A}, C_{B}, R_{A}, R_{B} calculated from L_{pkg}, R_{pkg}, Z_{A}, Z_{B}, ω_{B}. The capacitor cell 1 and the capacitor cell 2 are two types of capacitor cells having a different equivalent series resistance per capacitance, and have the following properties.

Cell type 1: Capacitance value C₁, Equivalent series resistance R₁, Area 1
Cell type 2: Capacitance value C₂, Equivalent series resistance R₂, Area 2
C_{A}, R_{A} are realized by connecting in parallel an n₁ number of capacitor cells 1, and C_{B}, R_{B} are realized by connecting in parallel an n₂ number of capacitor cells 1. Here, n₁ and n₂ are the number of capacitor cells that may be arranged estimated from the area of each cell.

The properties of the capacitor cell 1 are determined as follows.

C₁≧C_{A}/n₁ Formula 9

R₁≅R_{A}×n₁ Formula 10

The estimated arrangement number, i.e., an n₁ number of capacitor cells having an equivalent series resistance R₁, are connected in parallel to achieve R_{A}, and therefore the desired property is not satisfied if R₁ is too high or too low. The higher the value of C₁, the lower the impedance; however, at least C_{A}/n₁ is needed within a range of realizing R.

The properties of the capacitor cell 2 are determined as follows.

C₂≧C_{B}/n₂ Formula 11

R₂<R_{B}×n₂ Formula 12

The lower the R_{B}, the more preferable, and therefore the capacitor cell is designed such that R₂ is as low as possible.

Referring back to FIG. 6, the data of the capacitor cell 1 obtained as above is generated as a capacitor cell 1 library 51. Furthermore, the data of the capacitor cell 2 is generated as a capacitor cell 2 library 52. Next, in step S5, the chip is designed, and chip data 53 (layout data indicating the arrangement wiring of each circuit element) is generated. Next, by an arrangement system of the capacitor cells, in step S6, n₁ and n₂ are calculated. Furthermore, in step S7, the arrangement possible area is confirmed, and in step S8, the capacitor cells are arranged. Accordingly, chip data with capacitor cells 54 is generated.

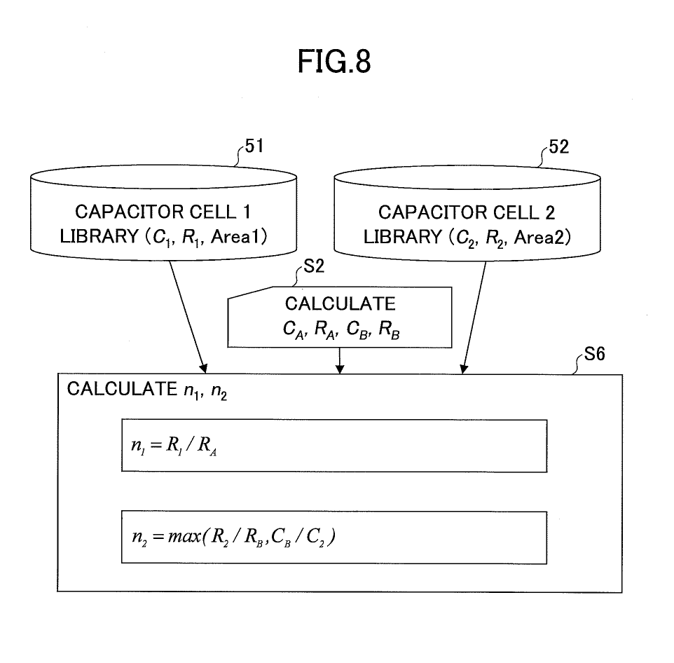

FIG. 8 schematically illustrates a process of calculating n₁ and n₂. As illustrated in FIG. 8, in order to realize desired combined capacitances C_{A} and C_{B} and desired equivalent series resistances R_{A} and R_{B}, the following number of capacitor cells 1 and capacitor cell 2 are arranged.

n₁=R₁/R_{A} Formula 13

n₂=max(R₂/R_{B},C_{B}/C₂) Formula 14

As to the capacitor cell 1, an n₁ number of capacitor cells 1 are arranged. If the number of capacitor cells 1 is too high, the combined equivalent series resistance decreases, and a resonance occurs. Furthermore, if the number of capacitor cells 1 is too low, the impedance is not decreased to the target value. Note that C₁ is designed such that C₁≧C_{A}/n₁ is satisfied, and therefore by arranging an n₁ number of capacitor cells 1, a capacitance value that is greater than or equal to C_{A} is realized.

The higher the number n₂ of capacitor cells 2, the more it is possible to decrease the impedance. Therefore, as in the above formula, n₂ is set to be the higher number between the number of capacitor cells for realizing R_{E}, by R₂, and the number of capacitor cells for realizing C_{B} by C₂. From the viewpoint of decreasing the impedance at the target frequency, the higher number n₂ of capacitor cells 2, the more preferable; however, it is not preferable to arrange a large number of capacitor cells 2 such that the resonance suppression effect and the resonance frequency of R_{A} are affected. Therefore, as a tentative target, the number of capacitor cells 2 to be arranged is set to be n₂ as obtained above.

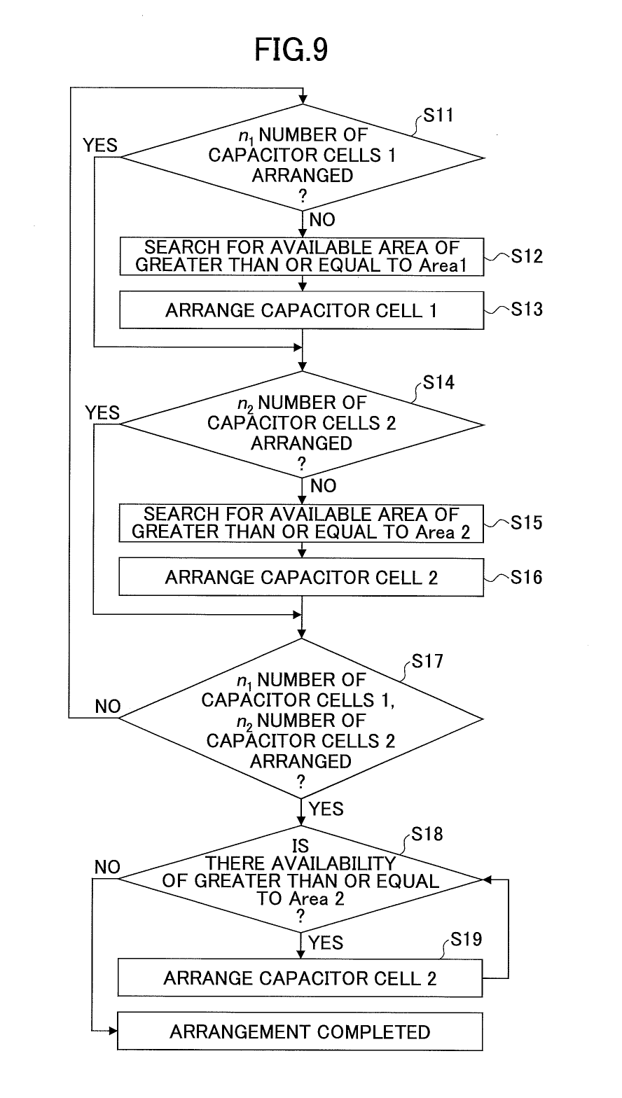

FIG. 9 is a flowchart indicating the flow of a process of arranging capacitor cells. The process of this flowchart corresponds to the capacitor cell arrangement process at step S8 of FIG. 6. Note that before executing this process, the possible arrangement area confirmation process of step S7 in FIG. 6 has been executed, and it has been confirmed that an n₁ number of capacitor cells 1 may be arranged, and an n₂ number of capacitor cells 2 may be arranged.

In step S11 of FIG. 9, it is determined whether an n₁ number of capacitor cells 1 have already been arranged. When an n₁ number of capacitor cells 1 have not yet been arranged, in step S12, an available area in the chip is searched, corresponding to greater than or equal to Area 1 of the capacitor cell 1, based on the chip data 13 (see FIG. 6). In step S13, the capacitor cell 1 is arranged in the available area found as a result of the search. Note that when it is determined in step S11 that an n₁ number of capacitor cells 1 have already been arranged, steps S12 and S13 are skipped.

In step S14, it is determined whether an n₂ number of capacitor cells 2 have already been arranged. When an n₂ number of capacitor cells 2 have not yet been arranged, in step S15, an available area in the chip is searched, corresponding to greater than or equal to Area 2 of the capacitor cell 2, based on the chip data 13 (see FIG. 6). In step S16, the capacitor cell 2 is arranged in the available area found as a result of the search. Note that when it is determined in step S14 that an n₂ number of capacitor cells 2 have already been arranged, steps S15 and S16 are skipped.

In step S17, it is determined whether an n₁ number of capacitor cells 1 have already been arranged, and whether an n₂ number of capacitor cells 2 have already been arranged. When the determination result of step S17 is NO, the process returns to step S11 and subsequent steps are repeated. When the determination result of step S17 is YES, the process proceeds to step S18, and based on chip data 53 (see FIG. 6), it is determined whether there is an available area in the chip corresponding to greater than or equal to Area 2 of the capacitor cell 2. When there is an available area in the chip corresponding to greater than or equal to Area 2 (YES in step S18), another capacitor cell 2 is arranged in step S19. By this arrangement of the capacitor cell 2, there are greater than or equal to an n₂ number of capacitor cells 2. When there is no available area in the chip corresponding to greater than or equal to Area 2 (NO in step S18), the arrangement is completed.

In the following, with the use of specific values, a description is given of an example of designing and arranging two types of capacitor cells. An LSI is designed, in which the first desired impedance Z_{A}=1 mΩ, the second desired impedance Z_{B}=0.1 mΩ, and the target frequency ω_{B}=3.14 GHz. This LSI is installed in a package in which the inductance L_{pkg}=1 pH, and the resistance value R_{pkg}=0.1 mΩ. Because the R_{pkg} is low, a process is performed for preventing a resonance. C_{A}, R_{A}, C_{B}, and R_{B} are obtained as follows.

$$\begin{matrix} {C}_{A} = \frac{{L}_{pkg}}{{Z}_{A}^{2}} = 1 pH / {( 1 m Ω )}^{2} = 1 μFZ & Formula 15 \\ {R}_{A} = {Z}_{A} = 1 m Ω & Formula 16 \\ {C}_{B} > \frac{1}{{ω}_{B} {Z}_{B}} = 1 / ( 2 \times π \times 3.14 GHz \times 0.1 m Ω ) = 507 nF & Formula 17 \\ {R}_{B} < {Z}_{B} = 0.1 m Ω & Formula 18\end{matrix}$$

Next, two types of capacitor cells for realizing the above capacitance values and resistance values are designed. Here, the number n₁ of capacitor cells 1 is 1×10⁷, and the number n₂ of capacitor cells 2 is 5.07×10⁶. In this case, the capacitor cell 1 (C₁, R₁) and the capacitor cell 2 (C₂, R₂) are designed as follows.

C₁=C_{A}/n₁=1 μF/(1×10⁷)=1×10⁻¹³ F=100 fF Formula 19

R₁≈R_{A}×n₁=1 mΩ×1×10⁷=10 KΩ Formula 20

C₂≧C_{B}/n₂=507 nF/5.07×10⁶=100fF Formula 21

R₂<R_{B}×n₂=0.1 mΩ×5.07×10⁶=507Ω Formula 22

According to the above, as to the capacitor cell 1, C₁=100 fF and R₁=10 kΩ. Furthermore, as to the capacitor cell 2, C₂=100 fF and R₂=507Ω.

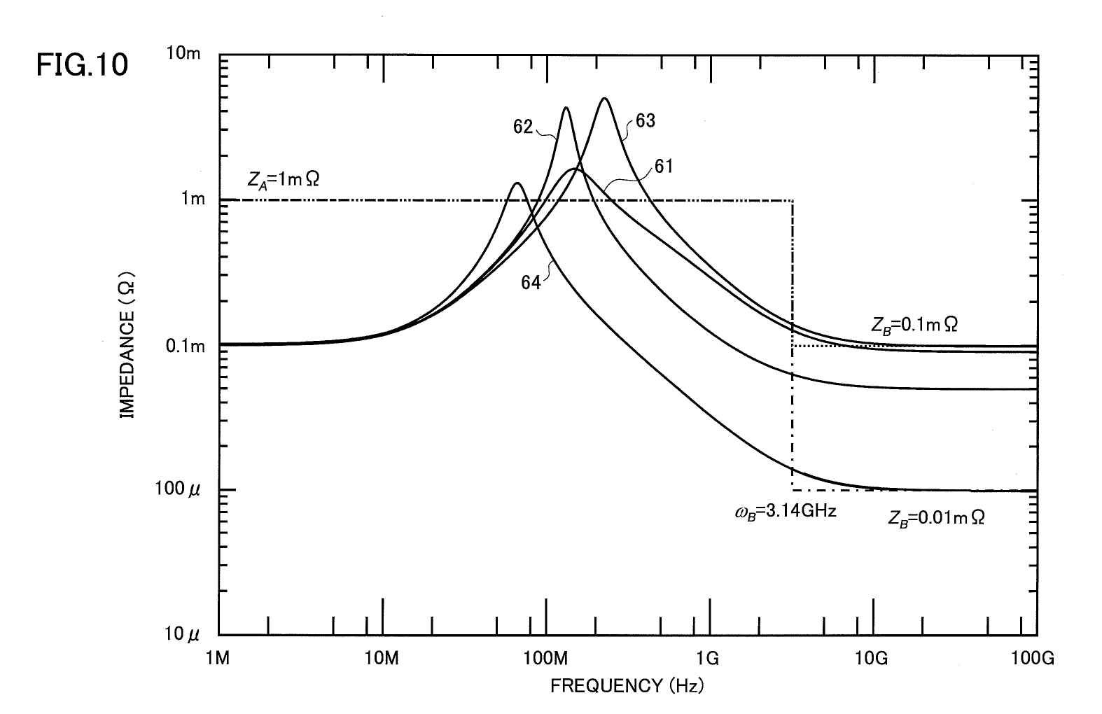

FIG. 10 illustrates impedance properties realized by combining two types of capacitor cells designed as described above. The horizontal axis indicates the frequency, and the vertical axis indicates the impedance. As described above, it is assumed that the LSI has a first desired impedance Z_{A}=1 mΩ, a second desired impedance Z_{B}=0.1 mΩ, and a target frequency ω_{B}=3.14 GHz. Furthermore, on the package side, the inductance is L_{pkg}=1 pH and the resistance value is R_{pkg}=0.1 mΩ.

An impedance curve 61 expresses an impedance obtained when a 1×10⁷ number of capacitor cells 1 (C₁=100 fF, R₁=10 kΩ) are arranged, and a 5.07×10⁶ number of capacitor cells 2 (C₂=100 fF, R₂=507Ω) are arranged. This impedance corresponds to a case where C_{A}=1 μF, R_{A}=1 mΩ, C_{B}=507 nF, and R_{B}=0.1 mΩ. The impedance near the resonance frequency is suppressed to near the first desired impedance Z_{A}=1 mΩ or less than or equal to the first desired impedance Z_{A}=1 mΩ. Furthermore, the impedance in the frequency band that is greater than or equal to the target frequency ω_{B}=3.14 GHz is suppressed to near the second desired impedance Z_{B}=0.1 mΩ or less than or equal to the second desired impedance Z_{B}=0.1 mΩ.

An impedance curve 62 is a comparison object, indicating an impedance in a case where the equivalent series resistance of the capacitor cell 1 is not R₂=10 kΩ but 1 kΩ, and other conditions are the same as those of the impedance curve 61. In this case, the equivalent series resistance value of the capacitor cell 1 is low, and therefore the impedance at the resonance frequency is high.

An impedance curve 63 is a comparison object, indicating an impedance in a case where the equivalent series resistance of the capacitor cell 1 is not R₂=10 kΩ but 100 kΩ, and other conditions are the same as those of the impedance curve 61. In this case, the equivalent series resistance value of the capacitor cell 1 is high, and therefore the impedance at the resonance frequency is low; however, the impact of the inductance of the package increases relatively, and therefore the impedance is high in the frequency domain higher than the resonance frequency.

An impedance curve 64 expresses an impedance obtained when a 1×10⁷ number of capacitor cells 1 (C₂=100 fF, R₂=10 kΩ) are arranged, and a 5.07×10 number of capacitor cells 2 (C₂=100 fF, R₂=507 ω) are arranged. That is to say, the impedance curve 64 expresses an impedance obtained when the number of arranged capacitor cells 2 is 10 times that of the case of the impedance curve 61. In this case, the impedance in a frequency band, which is greater than or equal to the target frequency ω_{B}=3.14 GHz, becomes a sufficiently low value, thereby satisfying the prerequisite for the case where the second desired impedance Z_{E}, is 0.01 mΩ. Furthermore, the impedance near the resonance frequency is also suppressed near the first desired impedance Z_{A}=1 mΩ or less than or equal to the first desired impedance Z_{A}=1 mΩ.

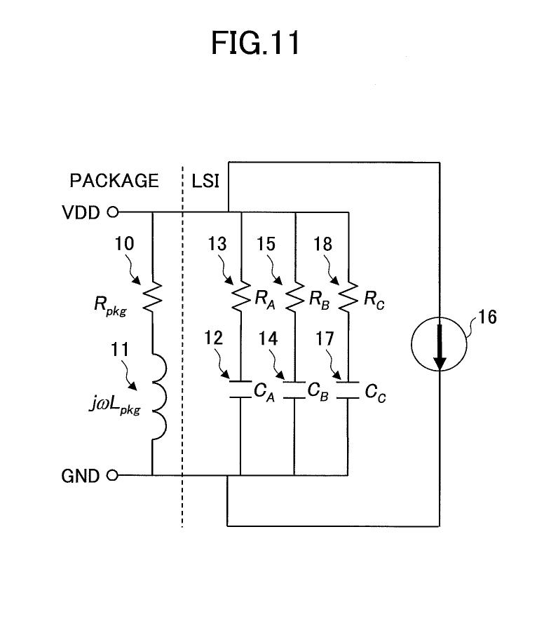

FIG. 11 illustrates a modification of the AC equivalent circuit of the power supply wiring of the semiconductor device illustrated in FIG. 1. In FIG. 11, elements that are the same as or corresponding to those of FIG. 1 are denoted by the same reference numerals and descriptions thereof are omitted. The AC equivalent circuit illustrated in FIG. 11 includes, in addition to the two capacitative elements and the two equivalent series resistances illustrated in FIG. 1, a third capacitative element 17 and an equivalent series resistance 18 of the third capacitative element 17. The capacitance value of the third capacitative element 17 is C_{C} and the resistance value of the equivalent series resistance 18 is R_{C}.

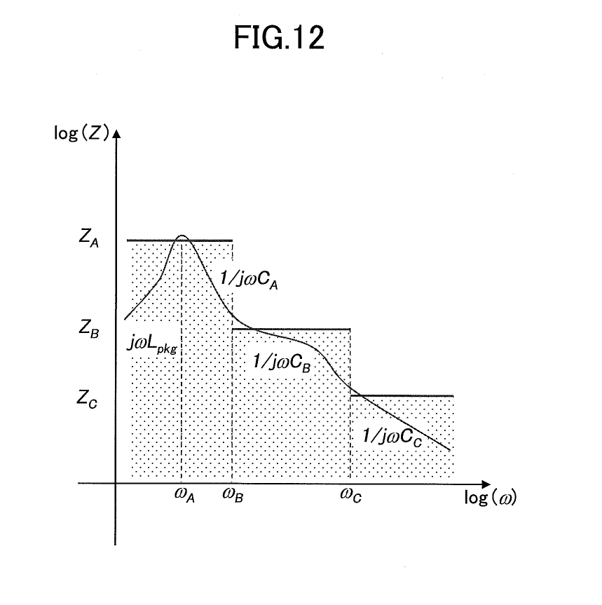

FIG. 12 schematically illustrates the desired impedances in the respective frequency bands of the semiconductor device illustrated in FIG. 11. The horizontal axis indicates the frequency and the vertical axis indicates the impedance. As illustrated in FIG. 12, the semiconductor device of FIG. 11 is designed to have an impedance that is near a first desired impedance Z_{A} or less than or equal to the first desired impedance Z_{A}, between the power supply voltage VDD and the ground voltage GND, in a domain that is less than or equal to the target frequency ω_{B}. Particularly, the semiconductor device is designed to have an impedance that is near a first desired impedance Z_{A} or less than or equal to the first desired impedance Z_{A}, between the power supply voltage VDD and the ground voltage GND, at the resonance frequency ω_{A} of the power supply wiring of the semiconductor device, in a domain that is less than or equal to the target frequency ω_{B}. Furthermore, the semiconductor device is designed to have an impedance that is near a second desired impedance Z_{E}, or less than or equal to the second desired impedance Z_{B}, between the power supply voltage VDD and the ground voltage GND, in a domain that is greater than or equal to a first target frequency ω_{B} and less than or equal to a second target frequency ω_{C}. Furthermore, the semiconductor device is designed to have an impedance that is near a third desired impedance Z_{C} or less than or equal to the third desired impedance Z_{C}, between the power supply voltage VDD and the ground voltage GND, in a domain that is greater than or equal to a second target frequency ω_{C}.

By using three types of capacitative elements and equivalent series resistances as illustrated in FIG. 11, it is possible to realize impedance properties as illustrated in FIG. 12. Specifically, a first desired impedance Z_{A} is achieved by the first capacitative element 12 and the equivalent serial resistance 13, a second desired impedance Z_{E}, is achieved by the second capacitative element 14 and the equivalent serial resistance 15, and a third desired impedance Z_{C} is achieved by the third capacitative element 17 and the equivalent series resistance 18. As described above, by using a combination of three or more types of capacitative elements and equivalent series resistance that are different from each other, it is possible to realize stepwise impedance properties of three or more steps.

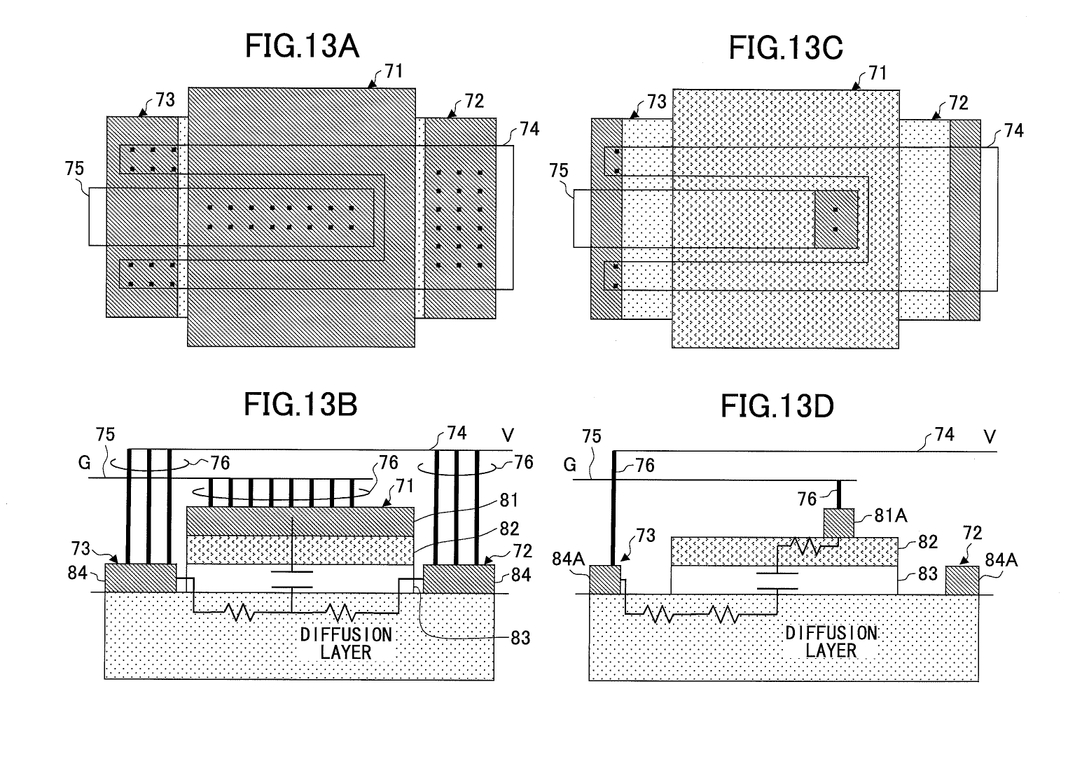

FIGS. 13A through 13D illustrate a configuration for adjusting the equivalent series resistance in a capacitor cell. FIGS. 13A and 13C are plan views of a semiconductor element of capacitor cells, and FIGS. 13B and 13D are side views of a semiconductor element of capacitor cells. FIGS. 13A and 13B illustrate a single semiconductor element, and FIGS. 13C and 13D illustrate another single semiconductor element.

As illustrated in FIGS. 13A through 13D, a gate 71 is electrically connected to a metal wiring 75 via a contact 76, and a source/drain 72 and a source/drain 73 are electrically connected to a metal wiring 74 via a contact 76.

In the semiconductor element illustrated in FIGS. 13A and 13B, a polysilicon electrode 82 is formed on a gate oxide film 83, a silicide 81 is formed on the entire top surface of the polysilicon electrode 82, and the contact 76 is connected to the silicide 81. Furthermore, a silicide 84 is formed on substantially the entire surface of the source/drain 72 and the source/drain 73, and the contact 76 is connected to the silicide 84. In this configuration, the value of the equivalent series resistance connected in series with the capacitative element is relatively low.

In the semiconductor element illustrated in FIGS. 13C and 13D, a polysilicon electrode 82 is formed on a gate oxide film 83, a silicide 81A is formed on only part of the top surface of the polysilicon electrode 82, and the contact 76 is connected to the silicide 81A. Furthermore, a silicide 84A is formed on only part of the entire area of the source/drain 72 and the source/drain 73, and the contact 76 is connected to the silicide 84A only on the side of the source/drain 73. In this configuration, the value of the equivalent series resistance connected in series with the capacitative element is relatively high, compared to that of the configuration illustrated in FIGS. 13A and 13B.

As described above, by adjusting the position and the area where the silicide is formed in a semiconductor element forming a capacitor cell, it is possible to adjust the equivalent series resistance value with respect to the capacitance. That is to say, it is possible to easily design a plurality of types of capacitor cells having the respective desired impedance properties.

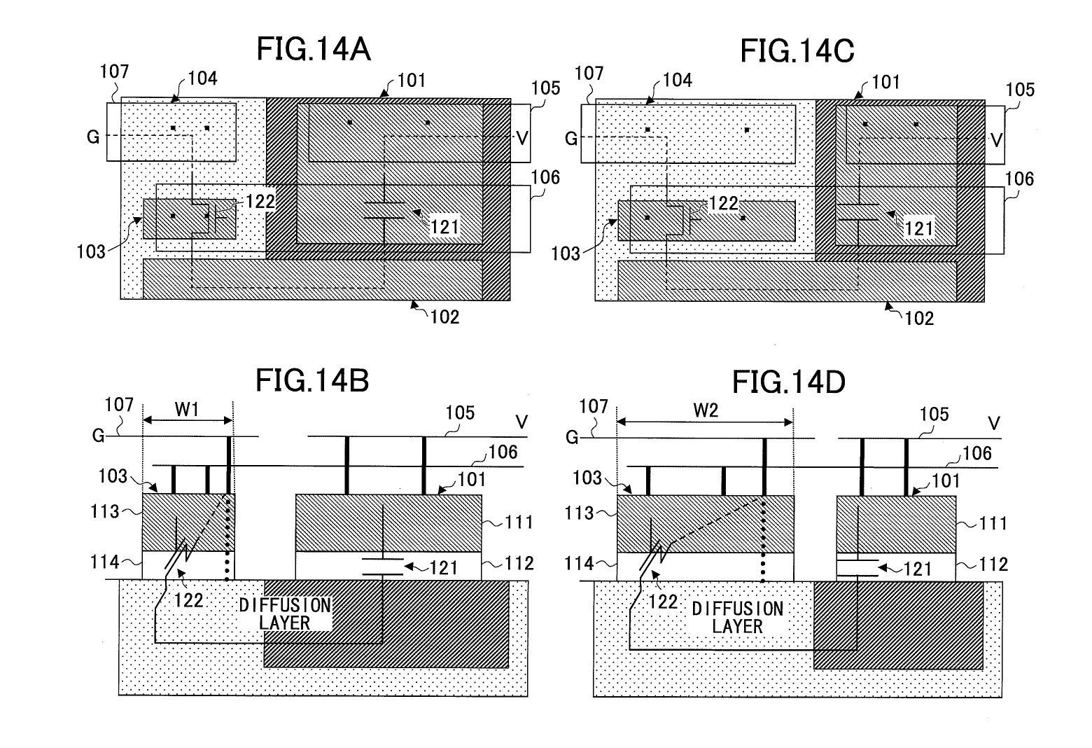

FIGS. 14A through 14D illustrate a configuration for adjusting the equivalent series resistance in a capacitor cell. FIGS. 14A and 14C are plan views of a semiconductor element of capacitor cells, and FIGS. 14B and 14D are side views of a semiconductor element of capacitor cells. FIGS. 14A and 14B illustrate a single semiconductor element, and FIGS. 14C and 14D illustrate another single semiconductor element.

As illustrated in FIGS. 14A through 14D, a gate 101 at a part constituting a capacitative element 121 is electrically connected to a metal wiring 105 via a contact, and a gate 103 at a part constituting a transistor 122 is electrically connected to a metal wiring 106 via the contact. Furthermore, a source/drain 104 of the transistor 122 is electrically connected to a metal wiring 107 via the contact.

At the gate 101 at a part constituting the capacitative element 121, a gate electrode 111 is formed on a gate oxide film 112, and the contact is connected to the gate electrode 111. Furthermore, at the gate 103 at a part constituting the transistor 122, a gate electrode 113 is formed on a gate oxide film 114, and the contact is connected to the gate electrode 113.

In the semiconductor element illustrated in FIGS. 14A and 14B, the transistor 122 having a gate width W1 is connected in series with the capacitative element 121. Furthermore, in the semiconductor element illustrated in FIGS. 14C and 14D, the transistor 122 having a gate width W2 is connected in series with the capacitative element 121. Therefore, by setting the gate widths W1 and W2 of the transistor 122 to be different to each other, it is possible to adjust the equivalent series resistance value with respect to the capacitance. That is to say, it is possible to easily design a plurality of types of capacitor cells having the respective desired impedance properties.

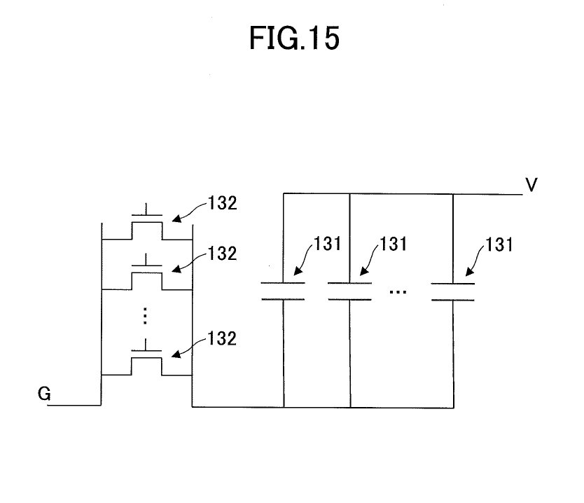

FIG. 15 illustrates a configuration by which it is possible to adjust the equivalent series resistance value with respect to the capacitance at the time of operation. In the circuit illustrated in FIG. 15, a plurality of capacitative elements 131 connected in parallel to each other, and a plurality of transistors 132 connected in parallel to each other, are connected to each other in series. Each of the capacitative elements 131 may be designed as a semiconductor element having a structure like the capacitative element 121 of FIG. 14, and each of the transistors 132 may be designed as a semiconductor element having a structure like the transistor 122 of FIG. 14. In a circuit having such a configuration, it is possible to adjust the equivalent series resistance value with respect to the capacitance, according to the number of transistors 132 that are turned on at the time of operation, i.e., according to the number of transistors 132 that set the gate to an assert state.

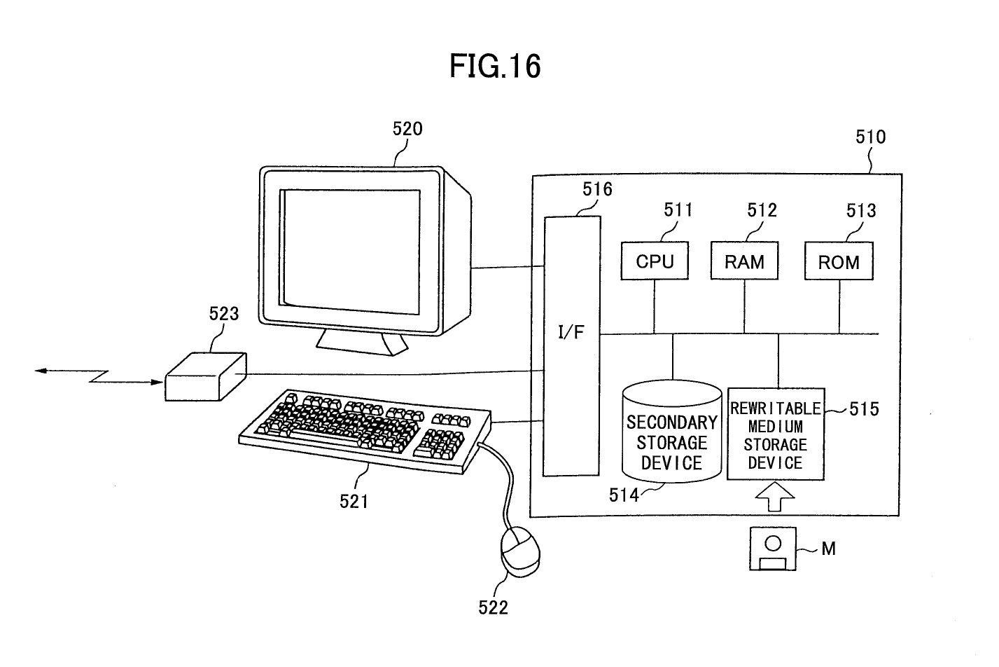

FIG. 16 illustrates a configuration of a device for executing a method of designing a semiconductor integrated circuit for arranging capacitor cells. As illustrated in FIG. 16, the device for executing a method of designing a semiconductor integrated circuit for arranging capacitor cells, is realized by a computer such as a personal computer and an engineering workstation. The device of FIG. 16 is constituted by a computer 510, a display device 520 connected to the computer 510, a communication device 523, and an input device. The input device includes, for example, a keyboard 521 and a mouse 522. The computer 510 includes CPU 511, a RAM 512, a ROM 513, a secondary storage device 514 such as a hard disk, a rewritable medium storage device 515, and an interface (I/F) 516.

The keyboard 521 and the mouse 522 are for providing an interface with the user, and receive input of various commands for operating the computer 510 and user responses to requested data. The display device 520 displays results, etc., processed by the computer 510, and displays various kinds of data to enable dialogues with a user when operating the computer 510. The communication device 523 is for communicating with a remote location, and constituted by, for example, a modem and network interface.

The method of designing a semiconductor integrated circuit for arranging capacitor cells is provided as a computer program executable by the computer 510. This computer program is stored in a storage medium M attachable to the rewritable medium storage device 515, and is loaded in the RAM 512 or the secondary storage device 514, from the storage medium M via the rewritable medium storage device 515. Alternatively, this computer program is stored in a storage medium (not illustrated) at a remote location, and is loaded in the RAM 512 or the secondary storage device 514, from the storage medium via the communication device 523 and the interface 516. The storage medium M is, for example, a CD-ROM, a CD-R/W, a DVD disk, and a USB memory.

When an instruction to execute the program is given by the user via the keyboard 521 and/or the mouse 522, the CPU 511 loads the program in the RAM 512, from the storage medium M, the storage medium at the remote location, or the secondary storage device 514. The CPU 511 uses the available storage space in the RAM 512 as a work area to execute the program loaded in the RAM 512, and proceeds with the process while performing a dialogue with the user accordingly. Note that the ROM 513 stores a control program for controlling the basic operations of the computer 510.

By executing the above computer program, the computer 510 executes the method of designing a semiconductor integrated circuit for arranging capacitor cells described in the above embodiment, as described below. Note that in the following description, the secondary storage device 514 and the RAM 512 are collectively referred to as “memory”.

First, the CPU 511 executes a program stored in the RAM 512, and calculates C_{A}, R_{A}, C_{B}, R_{B} based on various kinds of data (L_{pkg}, R_{pkg}, Z_{A}, Z_{B}, ω_{B}) stored in the memory. The calculated C_{A}, R_{A}, C_{B}, R_{B} is stored in the memory.

Furthermore, the CPU 511 executes the program to generate a capacitor cell 1 library 51 and a capacitor cell 2 library 52, based on the C_{A}, R_{A}, C_{B}, R_{B} stored in the memory. The generated capacitor cell 1 library 51 and capacitor cell 2 library 52 are stored in the memory. Furthermore, the CPU 511 executes the program to arrange the capacitor cell 1 and capacitor cell 2 in the chip (i.e., in the chip data 53), based on the capacitor cell 1 library 51 and capacitor cell 2 library 52 stored in the memory, and chip data 53. The chip data 53 after the arrangement is completed becomes the chip data realizing desired impedances in the respective frequency bands by inserting capacitative elements.

The present invention is not limited to the specific embodiments described herein, and variations and modifications may be made without departing from the spirit and scope of the present invention.

According to at least one aspect of the embodiments, a desired impedance value is achieved according to the frequency band.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of designing a semiconductor integrated circuit, comprising:
inserting, between a power supply voltage and a ground voltage, at least two types of capacitor cells which have a different ratio, the ratio being between an inverse number of a capacitance value of a capacitative element and a resistance value of an equivalent series resistance, such that an impedance between the power supply voltage and the ground voltage in a resonance frequency according to capacitances of the at least two types of capacitor cells and an external inductance, and an impedance between the power supply voltage and the ground voltage in a target frequency, are near respective desired values or less than or equal to the respective desired values.

2. The method according to claim 1, further comprising:
when generating the at least two types of capacitor cells,
determining a capacitance value of a first capacitative element according to the resonance frequency, the external inductance, and a first desired impedance;
determining a resistance value of an equivalent series resistance of the first capacitative element according to the first desired impedance;
determining a capacitance value of a second capacitative element according to the target frequency and a second desired impedance;
determining a resistance value of an equivalent series resistance of the second capacitative element according to the second desired impedance;
realizing the first capacitative element and the equivalent series resistance of the first capacitative element by connecting one or a plurality of first capacitor cells in parallel among the at least two types of capacitor cells; and
realizing the second capacitative element and the equivalent series resistance of the second capacitative element by connecting one or a plurality of second capacitor cells in parallel among the at least two types of capacitor cells.

3. The method according to claim 2, further comprising:
determining the capacitance value of the first capacitative element, such that a reactance in the resonance frequency of the first capacitative element is equal to both a reactance of the external inductance in the resonance frequency and the first desired impedance; and
determining the resistance value of the equivalent series resistance of the first capacitative element, to be equal to the first desired impedance.

4. The method according to claim 3, further comprising:
determining the capacitance value of the second capacitative element, such that a reactance in the target frequency of the second capacitative element is less than or equal to the second desired impedance; and
determining the resistance value of the equivalent series resistance of the second capacitative element, to be less than or equal to the second desired impedance.

5. A non-transitory computer-readable recording medium storing a program for designing a semiconductor integrated circuit, wherein the program causes a computer to execute a process comprising:
inserting, between a power supply voltage and a ground voltage, at least two types of capacitor cells which have a different ratio, the ratio being between an inverse number of a capacitance value of a capacitative element and a resistance value of an equivalent series resistance, such that an impedance between the power supply voltage and the ground voltage in a resonance frequency according to capacitances of the at least two types of capacitor cells and an external inductance, and an impedance between the power supply voltage and the ground voltage in a target frequency, are near respective desired values or less than or equal to the respective desired values.

6. The non-transitory computer-readable recording medium according to claim 5, the process further comprising:
determining a capacitance value of a first capacitative element according to the resonance frequency, the external inductance, and a first desired impedance;
determining a resistance value of an equivalent series resistance of the first capacitative element according to the first desired impedance;
determining a capacitance value of a second capacitative element according to the target frequency and a second desired impedance;
determining a resistance value of an equivalent series resistance of the second capacitative element according to the second desired impedance;
realizing the first capacitative element and the equivalent series resistance of the first capacitative element by connecting one or a plurality of first capacitor cells in parallel among the at least two types of capacitor cells; and
realizing the second capacitative element and the equivalent series resistance of the second capacitative element by connecting one or a plurality of second capacitor cells in parallel among the at least two types of capacitor cells.

7. The non-transitory computer-readable recording medium according to claim 6, the process further comprising:
determining the capacitance value of the first capacitative element, such that a reactance in the resonance frequency of the first capacitative element is equal to both a reactance of the external inductance in the resonance frequency and the first desired impedance; and
determining the resistance value of the equivalent series resistance of the first capacitative element, to be equal to the first desired impedance.

8. The non-transitory computer-readable recording medium according to claim 7, the process further comprising:
determining the capacitance value of the second capacitative element, such that a reactance in the target frequency of the second capacitative element is less than or equal to the second desired impedance; and
determining the resistance value of the equivalent series resistance of the second capacitative element, to be less than or equal to the second desired impedance.
